(19) United States
(12) Patent Application Publication
(10) Pub. No.: US 2006/0064397 A1
(43) Pub. Date: Mar. 23, 2006

(54) Network device, service using method, service using program product, and computer-readable recording medium recorded with a service using program

(76) Inventor: Yohko Ohtani, Tokyo (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 11/227,327

(22) Filed: Sep. 16, 2005

(30) Foreign Application Priority Data
Sep. 17, 2004 (JP) 2004-271711
Sep. 17, 2004 (JP) 2004-271712

(51) Int. Cl. G06F 17/30

(52) U.S. Cl. 707/1

(57) ABSTRACT

A network device capable of communicating to a Domain Name System (DNS) server including service records and using a service provided by a predetermined server, is disclosed, including a receiving part receiving the service records from the DNS server, an acquiring part acquiring service information for using the predetermined server, and a using part using the service based on the service information.

### BACKGROUND OF THE INVENTION

1. Field of the Invention

The present invention generally relates to a network device for using a service provided through a network, a service using method for using a service provided through a network, a service using program product, and a computer-readable recording medium recorded with a service using program for causing a computer to use a service through a network.

2. Description of the Related Art

There is a directory service as a service provided through a network. As a protocol in order to access this directory service, an LDAP (Lightweight Directory Access Protocol) has been provided. This LDAP is activated through TCP/IP (Transmission Control Protocol/Internet Protocol) and allows a user to access a directory management database in conformity to X.500 and create, change, delete, or search directory information.

In detail, for example, the LDAP is used for an electronic mail client to search for a registered user from a mail server or to manage shared resources accessible through the network. In addition, the LDAP can be used to use a security function such as an SLL (Secure Sockets Layer).

This LDAP has been conventionally used by an image forming apparatus because the image forming apparatus has provided a service using a network such as a service for transmitting a scanned image by electronic mail (hereinafter, called e-mail).

FIG. 1 is a diagram showing a process example in a case in that an image forming apparatus 1a acquires information concerning a specific user from a LDAP server 3. In FIG. 1, an application 1, a lower module 2, and a LDAP server 3 are shown. The application 1 and the lower module 2 are implemented in the image forming apparatus 1a.

In step S1, the application 1 sends an LDAP server information acquisition request to the lower module 2. In step S2, the lower module 2 sends LDAP server information to the application 1. In step S3, the application 1 sends an LDAP search request to the lower module 2.

In step S4, the lower module 2 sends a search request to the LDAP server 3. In step S5, the LDAP server 4 sends a search result 5 to the lower module 2. In step S6, when the lower module 2 receives the search result 5, the lower module 2 converts the search result 5 into LDAP user information 4, which is formed in a data structure used in the image forming apparatus 1a, and the lower module 2 sends the LDAP user information 4 to the application 1.

As described above, the image forming apparatus 1a acquires information from the LDAP server. As shown in FIG. 2, the search result 5 includes a name, a country name, an email address, a fax number, and a like.

In addition, as shown in FIG. 3, the LDAP user information 4 is information possible for data of the search result 5 to be processed in the image forming apparatus 1a.

As described above, the LDAP has been widely used for the image forming apparatus 1a. For example, by using the LDAP, the image forming apparatus 1a can search for a specific e-mail address.

A screen displayed at the image forming apparatus 1a in order to search the LDAP server will be described with reference to FIG. 4. In FIG. 4, a screen 11 is an LDAP server registration/change/deletion screen. When one LDAP server is registered to a button showing “NOT REGISTERED”, an LDAP server name is displayed on the button, instead of showing “NOT REGISTERED”. The LDAP server, which is registered, is changed or deleted by pressing the button

A screen 12 is another LDAP server registration/change/deletion screen. At the screen 12, the user inputs a name, a server name, a search start location, and a like. The search start location is a location of one cell in a database configured in a tree structure. Lower cells under that cell are subjects to be searched.

Next, at a screen 13, the user is required to set information to authenticate the user, and input a user name, a character code, and a like. Moreover, there may be additional screens provided in which the user may set information.

As described above, the user is required to input many setting items to use the LDAP, and is required to have a certain amount of knowledge concerning the LDAP. In addition, even if the user has the knowledge concerning the LDAP, a certain amount of workload is required to input the many setting items.

### SUMMARY OF THE INVENTION

It is a general object of the present invention to provide a network device for using a service provided through a network, a service using method for using a service provided through a network, a service using program product, and a computer-readable recording medium recorded with a service using program for causing a computer to use a service through a network, in which the above-mentioned problems are eliminated.

A more specific object of the present invention is to provide the network device for using a service provided through a network, the service using method for using a service provided through a network, the service using program product, and the computer-readable recording medium recorded with a service using program for causing a computer to use a service through a network, in which it is possible to easily set information for using the service provided through the network.

The above objects of the present invention are achieved by a network device capable of communicating to a Domain Name System server including service records and using a service provided by a predetermined server, said network device including: a receiving part receiving the service records from the Domain Name System server; an acquiring part acquiring service information for using the predetermined server; and a using part using the service based on the service information.

The service information may include a host name or an IP address of the predetermined server, and a port number.

The using part may send a service request for using the service with respect to the host name or the IP address, and the port number to the predetermined server.

The using part may send authentication information for using the service to the predetermined server.

The authentication information may be device authentication information defined for each of network devices.

The authentication information may be private authentication information defined for each user of network devices.

The authentication information may be stored beforehand in the network device.

The authentication information may be entered by a user of the network device.

The network device may further include a determining part determining whether or not the service is available to use based on the service information.

The service may be an Lightweight Directory Access Protocol, an File Transfer Protocol, an Simple Mail Transfer Protocol, or an Server Message Block.

Moreover, the above objects of the present invention are achieved by a network device capable of communicating to a Domain Name System server including service records and using a service provided by a predetermined server, the network device including: a receiving part receiving the service records from the Domain Name System server; an acquiring part acquiring service information for using the predetermined server; and a setting part setting information for using the service based on the service information.

The above objects of the present invention can be achieved by a service using method for conducting the above-described process, a program product for causing a computer to conduct the above-described processes, or a computer-readable recording medium recorded with a program for causing a computer to conduct the above-described processes.

### BRIEF DESCRIPTION OF THE DRAWINGS

In the following, embodiments of the present invention will be described with reference to the accompanying drawings.

FIG. 1 is a diagram showing a process example in a case in that an image forming apparatus acquires information concerning a specific user from a LDAP server;

FIG. 2 is a diagram showing a search result;

FIG. 3 is a diagram showing LDAP user information;

FIG. 4 is a diagram showing a LDAP server setting screen;

FIG. 5 is a diagram showing a system configuration according to an embodiment of a present invention;

FIG. 6 is a diagram showing a hardware configuration of an image forming apparatus;

FIG. 7 is a diagram showing a state in that the image forming apparatus acquires SRV records from a DNS server;

FIG. 8 is a diagram showing a process sequence in a process for the image forming apparatus to acquire the SRV records;

FIG. 9 is a diagram showing the SRV records describing information for each LDAP servers;

FIG. 10 is a diagram showing a host server name list;

FIG. 11 is a diagram showing a process sequence in a process for sending a search request to the LDAP server and acquiring a search result from the LDAP server;

FIG. 12 is a diagram showing search screens (part 1);

FIG. 13 is a diagram showing other search screens (part 2);

FIG. 14 is a diagram showing screens for selecting the LDAP server to search in a case in that the LDAP server is not required to be registered (part 1);

FIG. 15 is a diagram showing other screens for selecting the LDAP server to search in the case in that the LDAP server is not required to be registered (part 2);

FIG. 16 is a diagram showing a process sequence in a process for displaying the LDAP server being activated;

FIG. 17 is a diagram showing a display state of showing a server name list sent from a service management module;

FIG. 18 is a diagram showing an example displaying the LDAP servers being alphabetically sorted;

FIG. 19 is diagram showing a screen for indicating the DNS server to search for the LDAP server;

FIG. 20 is a diagram showing a screen for indicating authentication information;

FIG. 21 is a diagram showing a sequence process showing a process concerning an authentication;

FIG. 22 is a diagram showing a screen for setting the authentication information with respect to the LDAP server found by the DNS server;

FIG. 23 is a diagram showing an screen in a case of a registration as a system, regardless of the DNS server;

FIG. 24 is a diagram showing a screen for setting a representative authentication, a private authentication, or a manually entered authentication as an authentication type for each LDAP server;

FIG. 25 is a diagram showing a process sequence in a process concerning a search when the authentication type is set for each LDAP server;

FIG. 26 is a diagram showing a screen for setting the representative authentication as the authentication type with respect to the LDAP server;

FIG. 27 is a diagram showing a process sequence in a process conducted in a case of preparing the authentication information for each of several representative authentications;

FIG. 28 is a diagram showing a process sequence in a process for storing authentication information, by which the authentication is successfully conducted, and for using the authentication information for a next authentication; and

FIG. 29 is a diagram showing a process sequence in a process for displaying an authentication information input screen when the authentication is failed.

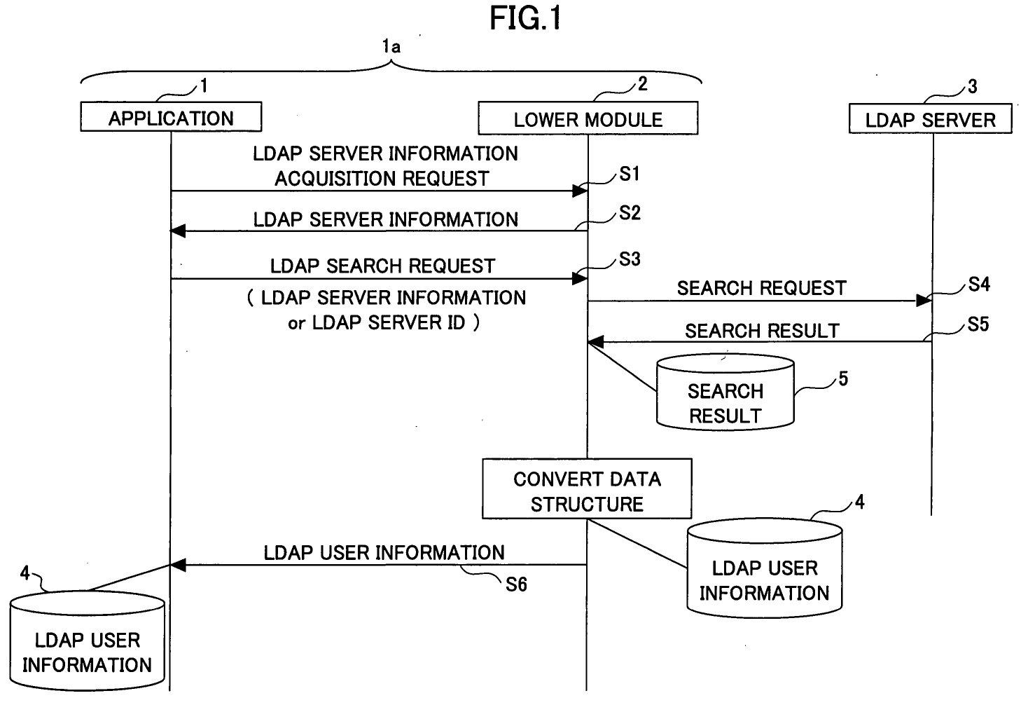

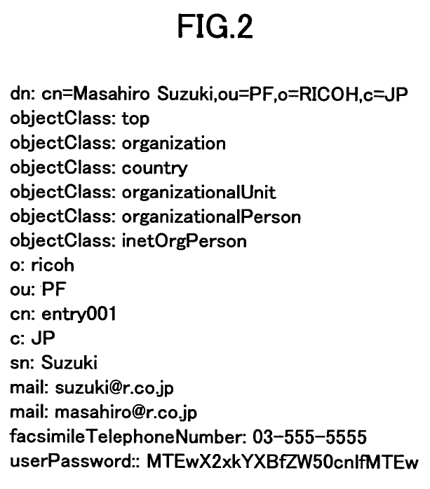

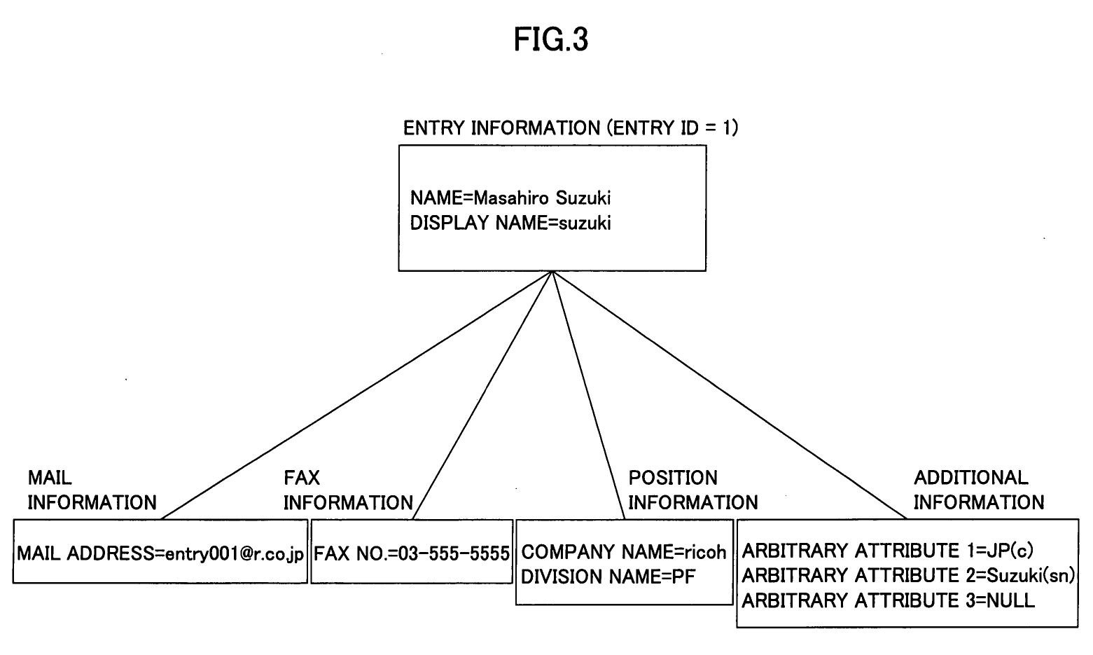

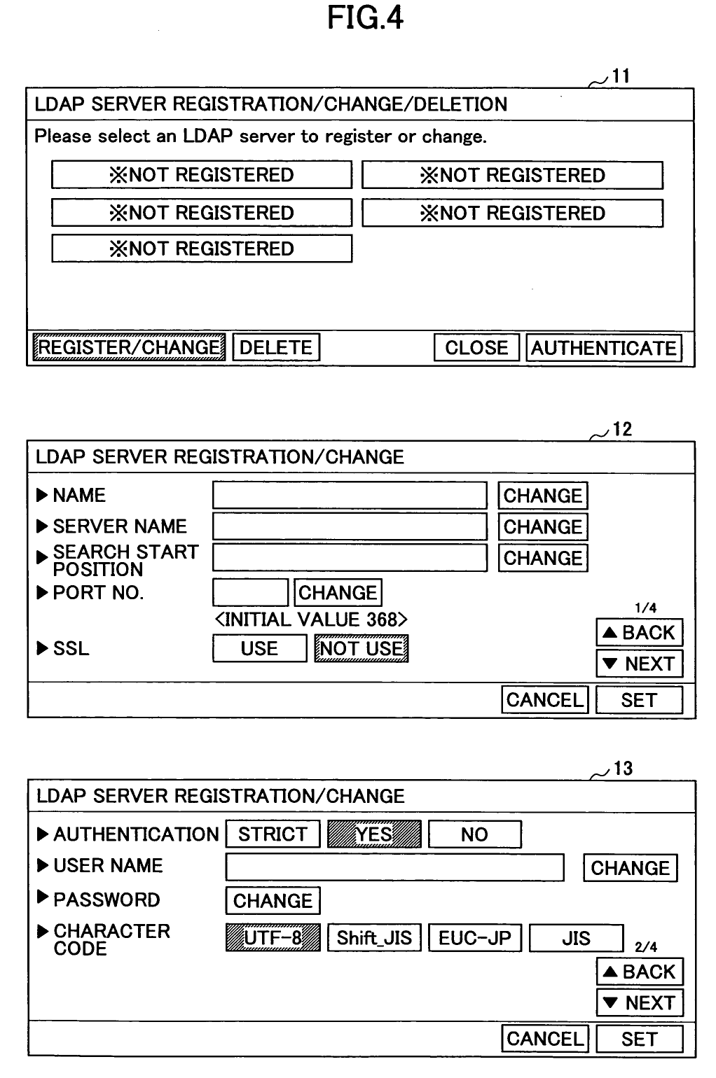

### DESCRIPTION OF THE PREFERRED EMBODIMENT

In the following, an embodiment of the present invention will be described with reference to the accompanying drawings. In the embodiment, a network device corresponds to an image forming apparatus. As a service provided through a network, there are an LDAP (Lightweight Directory Access Protocol), an FTP (File Transfer Protocol), an SMTP (Simple Mail Transfer Protocol), an SMB (Server Message Block), and a like. In the embodiment, the LDAP is exemplified as the service.

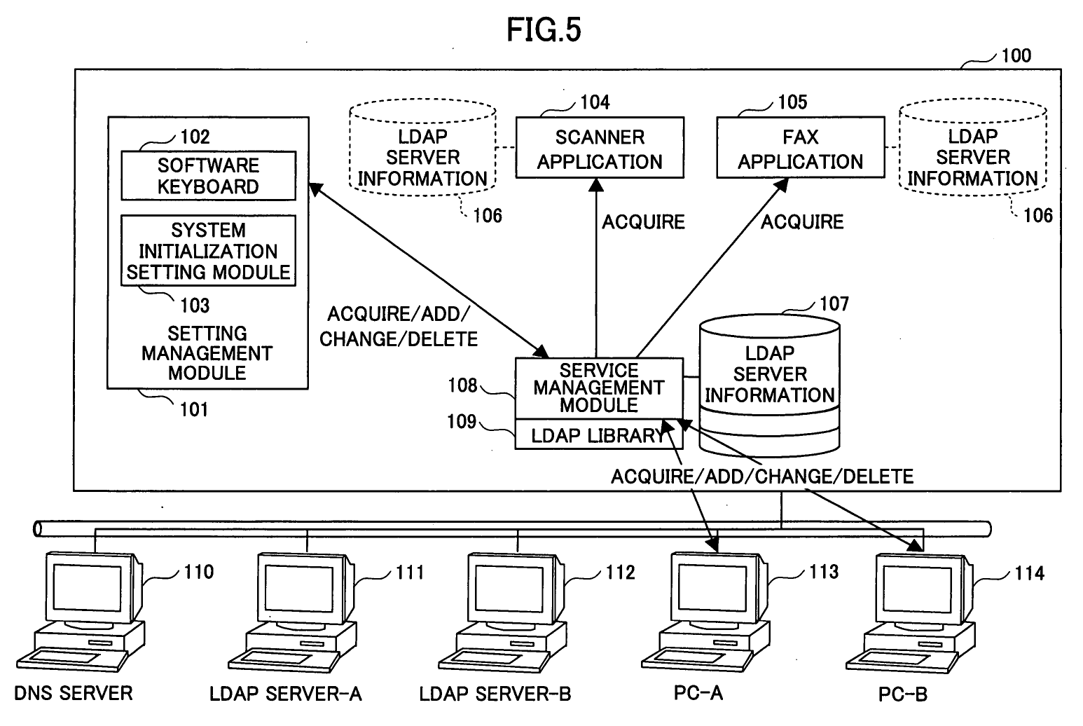

FIG. 5 is a diagram showing a system configuration according to the embodiment of the present invention. In FIG. 5, a DNS (Domain Name System) server 110, an LDAP server-A 111, an LDAP server-B 112, a PC-A 113, a PC-B 114, and an image forming apparatus 100 are shown as the entire system configuration. A software configuration of the image forming apparatus 100 is also shown in FIG. 5.

The DNS server 110 provides an SRV (service) record defined by an RFC (Request For Comment) 2783, to the image forming apparatus 100. The LDAP server-A 111 and the LDAP server-B 112 are server computers that provide directory services to the image forming apparatus 100. The PC-A 113 and the PC-B 114 acquire, add, change, or delete LDAP server information from/to the image forming apparatus 100.

Next, the software configuration of the image forming apparatus 100 will be described. Software of the image forming apparatus 100 includes a scanner application 104, a fax application 105, a setting management module 101, a service management module 108, and an LDAP library 109. Moreover, the image forming apparatus 100 includes LDAP server information 107. LDAP server information 106, which is shown by a dotted line, is prepared by the scanner application 104 or the fax application 105 if necessary.

The scanner application 104 is an application for a scanner. The fax application 105 is an application for a facsimile.

The setting management module 101 sends a request for acquiring, adding, changing, or deleting the LDAP server information 107, to the service management module 108. Moreover, the setting management module 101 includes a software keyboard module 102, and a system initialization setting module 103. The software keyboard module 102 realizes a keyboard function on an operating system mounted in the image forming apparatus 100. The system initialization setting module 103 conducts a system initialization setting for the image forming apparatus 100.

The service management module 108 is a module for managing and providing the LDAP server information. The LDAP library 109 is a library used to conduct various processes concerning the LDAP.

The LDAP server information 107 records information concerning settings of the LDAP, and includes a server name of the LDAP server, a host name or an IP address, a port number, a search start location, authentication information, an arbitrary search condition, a character code, and a like.

The service management module 108 corresponds to a receiving part, an acquiring part, and a determining part. Moreover, the applications 104 and 105 and the service management module 108 correspond to a using part.

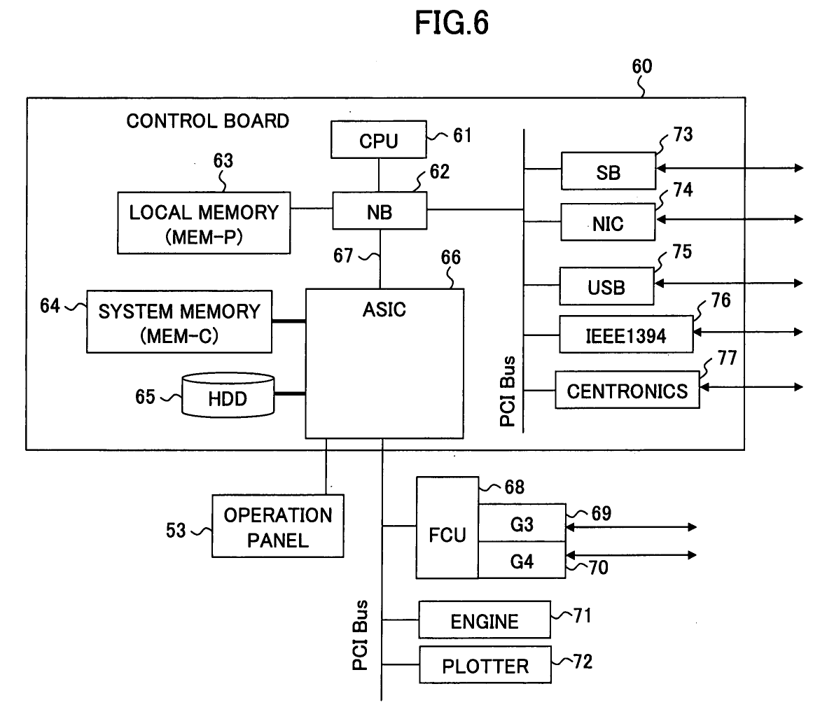

Next, a hardware configuration of the image forming apparatus 100 will be described with reference to FIG. 6. The image forming apparatus 100 includes a control board 60, an operation panel 53, an FCU (Fax Control Unit) 68, an engine 71, and a plotter 72. Moreover, the FCU 68 includes a G3 unit 69 in compliance with a G3 standard, and a G4 unit 70 in compliance with a G4 standard.

The control board 60 includes a CPU (Computer Processing Unit) 61, an ASIC (Application Specific Integrated Circuits) 66, an HDD (Hard Disk Drive) 65, a local memory (MEM-C) 64, a system memory (MEM-P) 63, a north bridge (NB) 62, a south bridge (SB) 73, an NIC (Network Interface Card) 74, a USB (Universal Serial Bus) device 75, an IEEE 1394 device 76, and a centronics device 77.

The operation panel 53 is connected to the ASIC 66 of the control board 60. The SB 73, the NIC 74, the USB device 75, the IEEE 1394 device 76, and the centronics device 77 are connected to the NB 62 via a PCI (Peripheral Component Interconnect) bus.

Moreover, the FCU 68, the engine 71, and the plotter 72 are connected to the ASIC 66 of the control board 60 via a PCI bus 67b.

In the control board 60, the local memory 64, the HDD 65, and the like are connected to the ASIC 66, and also, the CPU 61 and the ASIC 66 are connected to each other via the NB 62 as a CPU chipset. As described above, the CPU 61 and the ASIC 66 are connected to each other via the NB 62, so as to support a case in that an interface of the CPU 61 is not open in public.

The ASIC 66 and the NB 62 are connected to each other via an AGP (Accelerated Graphics Port) 67, instead of a PCI bus. As described above, in order to execute and control at leas one process of the applications 104 and 105 and modules 101 and 108 shown in FIG. 5 and the like, the ASIC 66 and the NB 62 are connected to each other through the AGP 67 other than the PCI bus having a slower speed, so as to prevent a performance deterioration.

The CPU 61 controls the entire image forming apparatus 100. The CPU 61 activates and executes the setting management module 101 and the service management module 108 as respective processes on the OS (Operating System), and also activates and executes the fax application 105 and the scanner application 104.

The NB 62 is an bridge for connecting the CPU 61, the system memory 63, the SB 73, and the ASIC 66 to each other. The system memory 63 is used as a memory to draw an image. The SB 73 is a bridge for connecting the NB 62 to a PCI bus 72c and peripheral devices. Moreover, the local memory 64 is used as a memory for buffering an image to copy and codes.

The ASIC 66 is an IC (Integrated Circuit) for an image processing device including hardware elements for an image process. The HDD 65 is storage for accumulating image data, document data, programs, font data, forms, and a like. Moreover, the operation panel 53 is an operation part for receiving input data by operations of a user and displaying information for the user.

In the above, the software and the hardware configuration of the image forming apparatus 100 are described. Next, processes will be described according to the embodiment of the present invention. First, a process for the image forming apparatus 100 to acquire SRV records will be described. This SRV records correspond to service information.

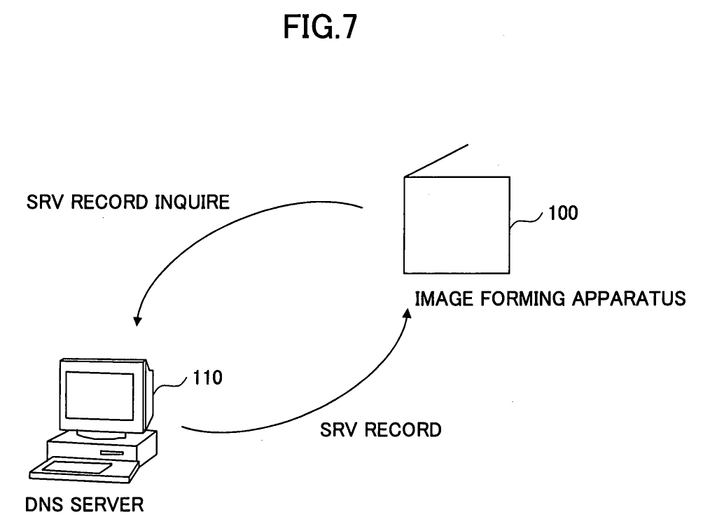

FIG. 7 is a diagram showing a state in that the image forming apparatus 100 acquires the SRV records from the DNS server 110. As shown in FIG. 7, the image forming apparatus 100 inquires the SRV records to the DNS server 110, and then, the SRV records 125 are provided from the DNS server 110 to the image forming apparatus 100.

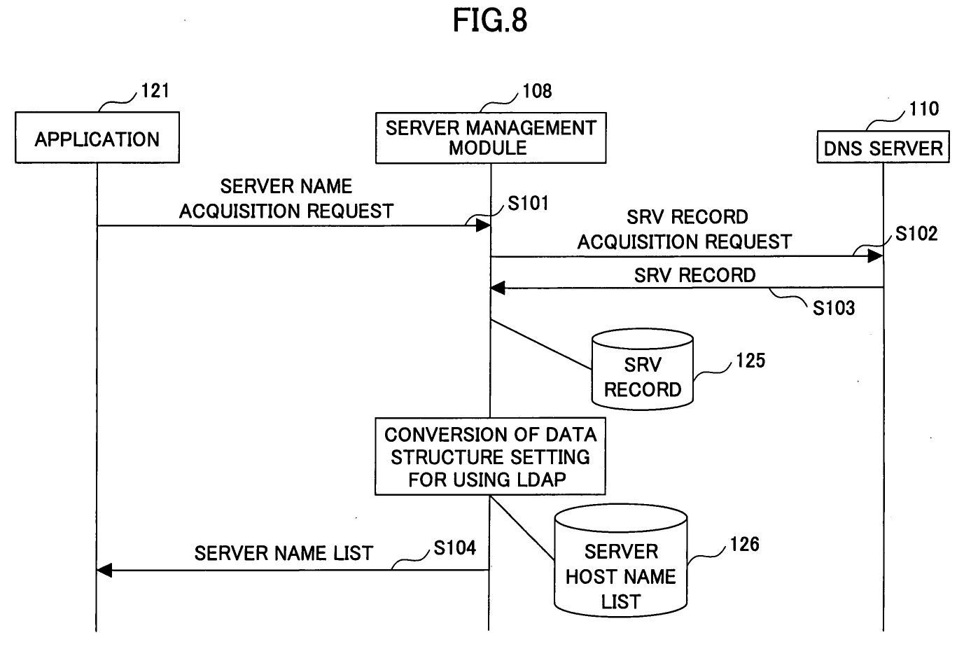

This process for acquiring the SRV records 125 will be described with reference to FIG. 8. FIG. 8 is a diagram showing a process sequence among an application 121, the service management module 108, and the DNS server 110 in the process for acquiring the SRV records 125. The application 121 shows the fax application 105 or the scanner application 104.

In step S101, the application 121 sends a server name acquisition request to the service management module 108. In step S102, the service management module 108 sends an SRV record acquisition request to the DNS server 110. The DNS server 110 sends the SRV records 125 to the service management module 108 in step S103 corresponding to a receiving step.

When the service management module 108 receives the SRV records 125, the service management module 108 converts the SRV records 125 into a server host name list 126 in a data structure. This data conversion corresponds to an acquisition step. Moreover, in this stage, based on the SRV records, the settings are made to use the LDAP.

In step S104, the service management module 108 sends the server host name list 126 to the application 121.

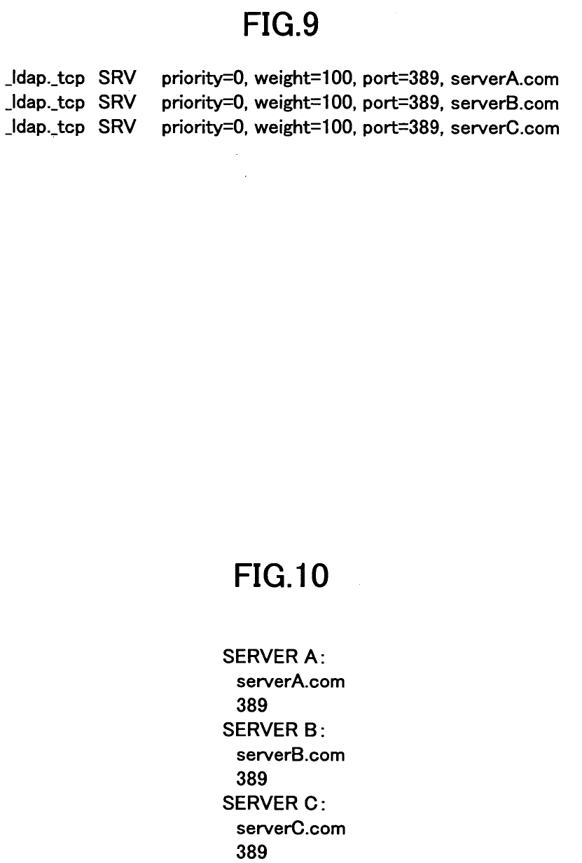

The SRV records 125 will be described with reference to FIG. 9. FIG. 9 is a diagram showing the SRV records 125 describing information for each of three LDAP servers. As shown in FIG. 9, each of the SRV records 125 indicates a protocol, a priority for a process order, a port number, a host name, and a like. By using the SRV records 125, it is possible to communicate with the LDAP server. It should be noted that data corresponding to the host name can be an IP address, instead of the host name.

Next, the server host name list 126 will be described with reference to FIG. 10. The server host name list 126 shown in FIG. 10 shows a server name, a host name, a port number of each of three servers acquired from the SRV records 125. As described above, the server host name list 126 records information included in the SRV records 125, and information necessary to communicate with the LDAP server.

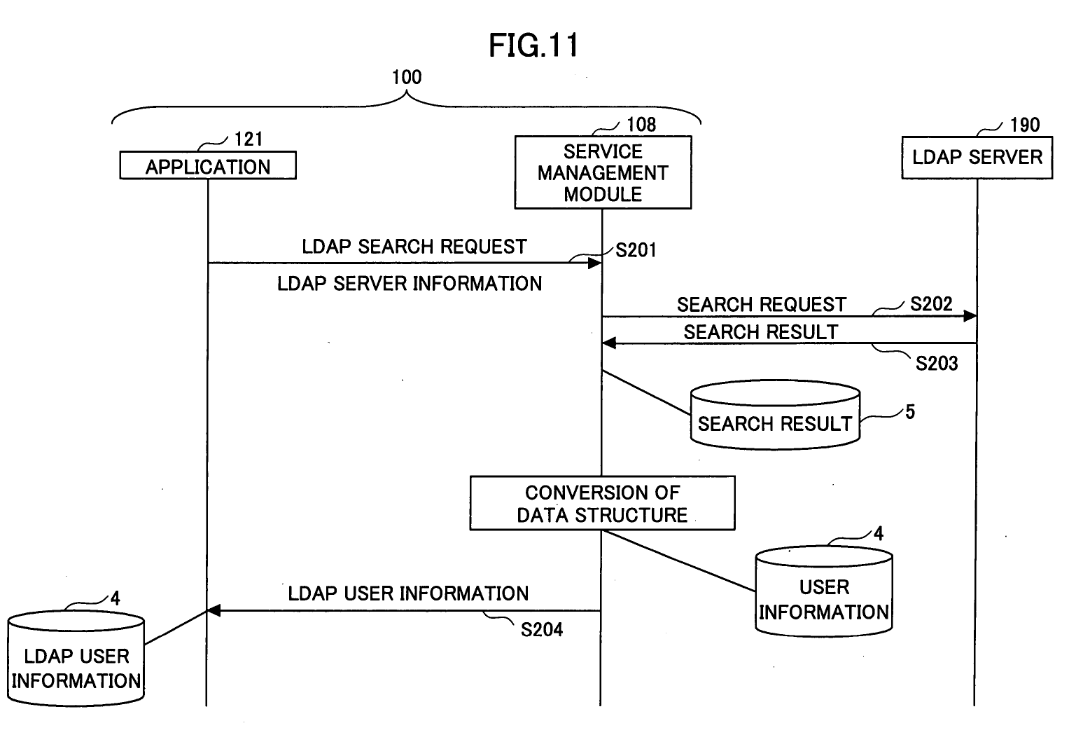

When necessary information is recorded, the LDAP server is ready to search. A process for requesting a search of the LDAP server and acquiring a search result will be described with reference to FIG. 11. FIG. 11 is a diagram showing a process sequence among the application 121, the service management module 108, and an LDAP server 190 in the process for requesting a search of the LDAP server and acquiring a search result.

In step S201, the application 121 sends an LDAP search request to the service management module 108 with the LDAP server information being previously recorded. In step S202, the service management module 108 sends a search request to the LDAP server 190. In step S203, the LDAP server 190 sends a search result 5 to the service management module 108. This search result 5 is converted into LDAP user information 4 in a data structure by the service management module 108. In step S204, the LDAP server information 4 is sent from the service management module 108 to the application 121.

In the above, the process sequence from a process for acquiring the SRV record to a search process is described. The step S201 through the step S204 correspond to a using step.

Next, screens and a screen flow in the above process will be described. In the following, parts that are the same as those shown in the previously described figures are given the same reference numbers, and explanations thereof will be omitted.

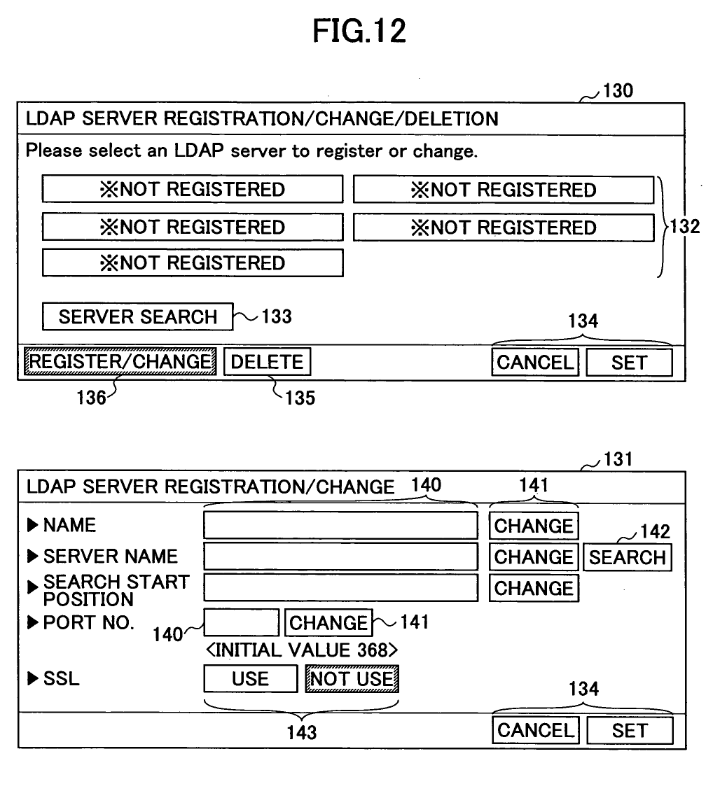

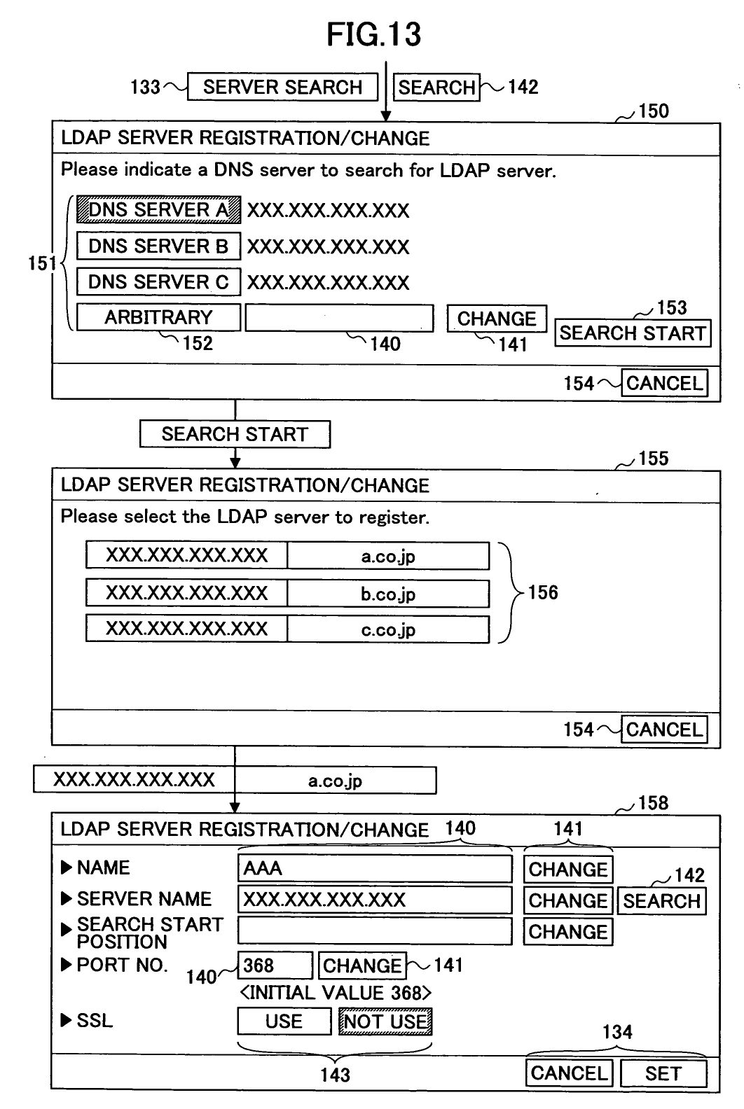

FIG. 12 and FIG. 13 are diagrams showing search screens. In FIG. 12, two screens 130 and 131 are shown. The screens 130 and 131 are used to start a search, and any one of theses screens 130 and 131 can be used to conduct the search. The screen 130 shows LDAP server buttons 132, a server search button 133, a register/change button 136, a delete button 135, and cancel and set buttons 134.

The LDAP server buttons 132 display a name of the LDAP server being registered, and are pressed when the LDAP server corresponding to the name displayed on the LDAP server buttons 132 are registered, changed, or deleted. In this case, since the LDAP server is not registered to any one of the LDAP server buttons 132, each of the buttons 132 displays “NOT REGISTERED”.

The server search button 133 is a button for searching for the LDAP server. The register/change button 136 is a button for registering or changing the LDAP server being registered to one of the buttons 132. The delete button 135 is a button for deleting the LDAP server being registered to one of the buttons 132. The cancel and set buttons 134 are a button for setting information concerning a screen which is currently opened and a button for canceling the settings concerning the screen which is currently opened.

Next, the screen 131 will be described. The screen 131 shows input fields 140, change buttons 141, a search button 142, utilization buttons 143, and cancel/set buttons 134. The input fields 140 are used to input a name of the LDAP server, a server name, a search start location, and a port number. The change buttons 141 are used to change the settings that are previously set. The utilization buttons 143 are selectively used to indicate whether or not an SSL (Secure Socket Layer) is used. The search button 142 is a button for searching for the LDAP server.

From the above-described two screens 130 and 131, it is possible to search for the LDAP server. A search for the LDAP server can be conducted when the server search button 133 is pressed in a case of the screen 130 or when the search button 142 is pressed in a case of the screen 131.

When the server search button 133 is pressed in a case of the screen 130 or when the search button 142 is pressed in a case of the screen 131, a screen 150 shown in FIG. 13 is displayed. The screen 150 shows DNS server buttons 151, an arbitrary button 152, an input field 140, a change button 141, a search start button 153, and a cancel button 154. In addition, IP addresses of the DNS servers are shown beside the DNS server buttons 151.

In this case, each “XXX.XXX.XXX.XXX” is displayed beside each of the DNS server buttons 151, and represents the IP address for each of the DNS servers. In the following, “XXX.XXX.XXX.XXX” also represents the IP address.

The DNS server buttons 151 are used to select one of the DNS servers in order to search for the LDAP server. The arbitrary button 152 is used to select an arbitrary DNS server. The search start button 153 is used to cause the DNS server selected by pressing one of the DNS server buttons 151 to search for the LDAP server.

When the search start button 153 is pressed to search and a search ends, a search result is shown in a screen 155. The screen 155 shows LDAP server buttons 156 and a cancel button 154. IP addresses of the LDAP servers found by this search are shown on the LDAP server buttons 156, respectively. One of the LDAP servers to be registered or changed is selected by pressing a respective LDAP server button 156.

In this case, when the LDAP server of “a.co.jp” is selected, a screen 158 is displayed as a next screen. The screen 158 shows the name, the server name, and the port number displayed for the LDAP server which is selected, in addition to the screen 131 shown in FIG. 12.

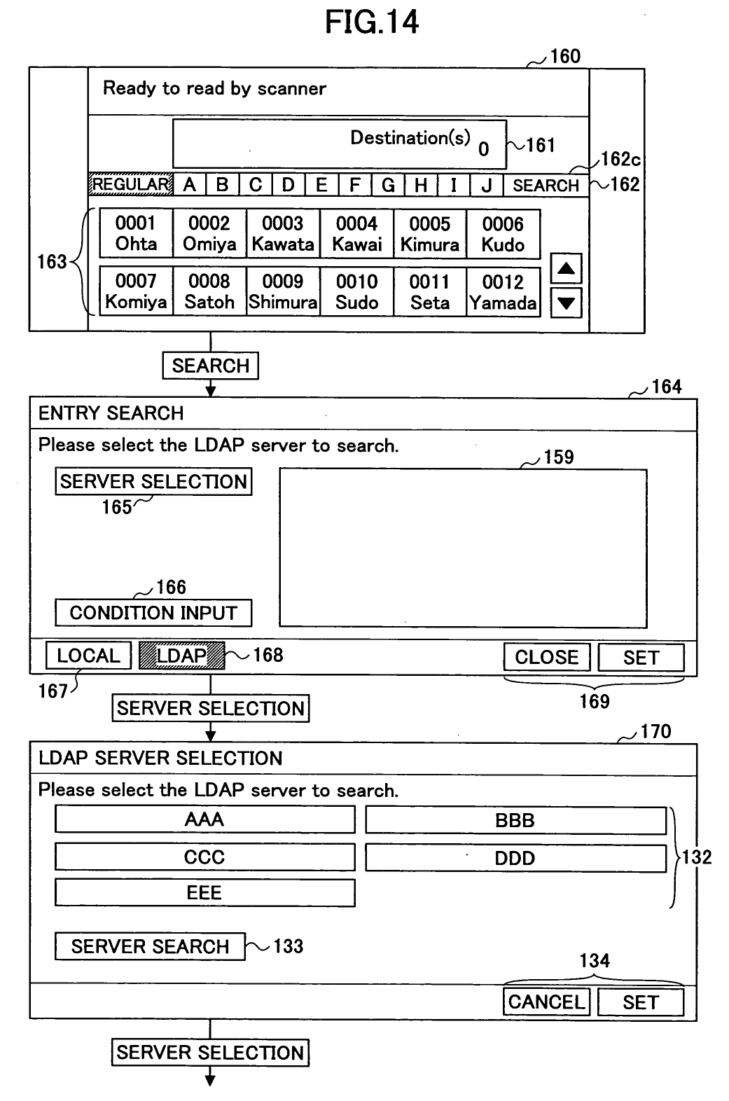

As described above, it is possible to register the LDAP server. Next, an example, in which a registration of the LDAP server is not required since the SRV records are used, will be described. First, screens shown in FIG. 14 will be described. FIG. 14 is a diagram showing screens for selecting the LDAP server to search.

A screen 160 is a search screen for searching for a destination in a case of the scanner. This screen 160 shows a search result field 161, search reference buttons 162, and individual buttons 163.

The search result field 161 shows a search result. The search reference buttons 162 are used to search by inputting characters as a search key or to conduct a regular search. The individual buttons 163 shows destinations which have been already registered.

At the screen 160, when a search button 162c is pressed, a screen 164 is displayed. The screen 164 shows a server selection button 165, a condition input button 166, a server display field 159, a local button 167, an LDAP button 168, and close and set buttons 169.

The server selection button 165 is a button to forward to a next screen for selecting an LDAP server to search. The condition input button 166 is a button for inputting a search condition. The local button 167 is a button for searching within the image forming apparatus 100 displaying this screen 164. The LDAP button 168 is a button for searching by using the LDAP server. The close and set buttons 169 are buttons for closing the screen 164 and setting contents currently displayed at the screen 164.

At the screen 164, when the server selection button 165 is pressed, a screen 170 is displayed. The screen 170 shows LDAP server buttons 132, a server search button 133, and cancel and set buttons 134.

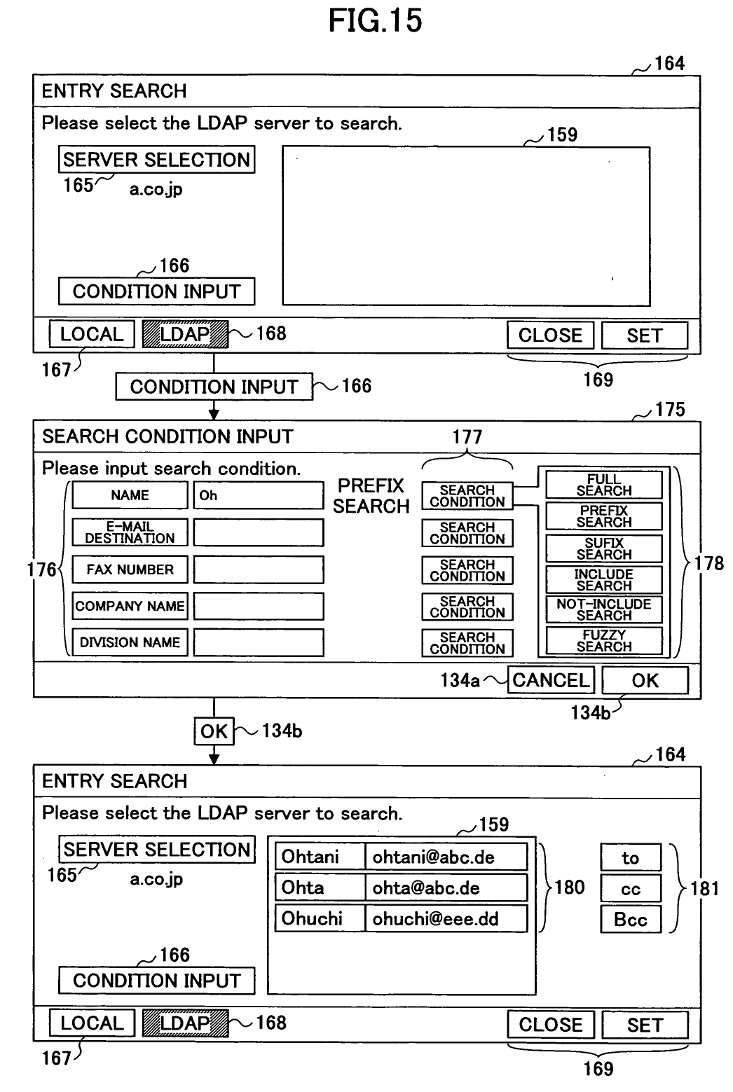

At the screen 170, when the server search button 133 is pressed, the screen 150 (see FIG. 13) is displayed. When the settings of contents are conducted similarly as described with reference to FIG. 13, the screen 155 (see FIG. 13) is displayed, and then a screen 164 in FIG. 15 is displayed.

At the screen 164 in FIG. 15, an LDAP server “a.co.jp” is shown additionally with respect to the screen 164 in FIG. 14. At the screen 164, when the condition input button 166 is pressed, a screen 175 is displayed. The screen 175 shows a search condition input fields 176, a search condition buttons 177, detailed search condition buttons 178, a cancel button 134a, and an OK buttons 134b.

The search condition input fields 176 allows a user to search for the LDAP server for each of items such as a name, e-mail destination, a fax number, a company name, and a division name. The search condition buttons 177 are buttons for displaying detailed search condition buttons 178. The detailed search condition buttons 178 includes various buttons for a full search, a prefix search, a suffix search, an include search, a not-include search, and a fuzzy search.

At the screen 175, when “Oh” for the name is input as a search condition, and the OK button 134b is pressed, a screen 164 is displayed. The screen 164 shows a search result 180, and send indication buttons 181. As the search result 180, names beginning from “Oh” are displayed.

As described above, by using the SRV records, the LDAP server is not required to be registered.

In the above-described processes, for example, the screen 155 (see FIG. 13) is displayed to show the LDAP server name list. However, there is a case in that the LDAP server operates as a computer but does not operate as the LDAP server. In this case, even if the user indicates the LDAP server listed at the screen 155, the user cannot search for the LDAP server.

Next, a process, in which only the LDAP servers being currently activated are listed by conducting a connection test to the LDAP servers, will be described. The connection test is to send an authentication request, a search request, and a like to each of the LDAP servers, and determine whether or not each of the LDAP servers is currently activated.

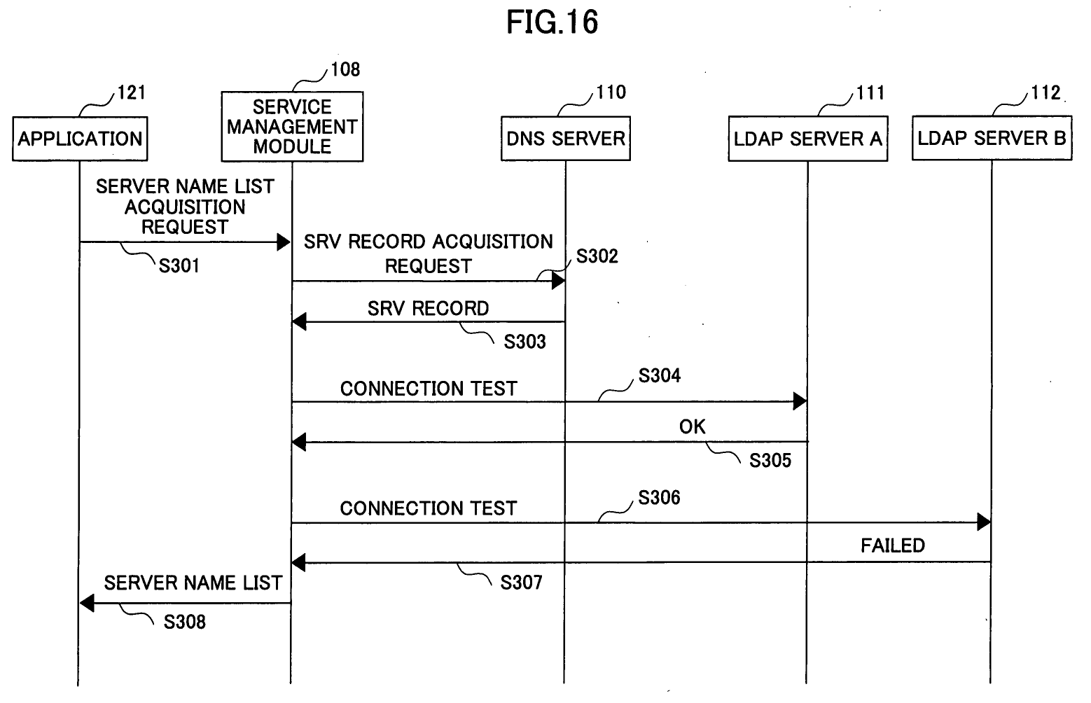

FIG. 16 is a diagram showing a process sequence in the process for listing the LDAP servers being currently activated. FIG. 16 shows the process sequence among the application 121, the service management module 108, the DNS server 110, the LDAP server-A 111, and the LDAP server-B 112.

In step S301, the application 121 sends a server name list acquisition request to the service management module 108. In step S302, the service management module 108 sends an SRV record acquisition request to the DNS server 110. In step S303, the DNS server 110 sends the SRV records to the service management module 108.

In step S304 and step S305, the service management module 108 conducts the connection test to the LDAP server-A 111, and confirms an existence accuracy of the LDAP server-A 111. Similarly, in step S306 and step S307, the service management module 108 conducts the connection test to the LDAP server-B 112. In this case, the existence accuracy of the LDAP server 112 cannot be confirmed.

In step S308, based on a connection test result, the service management module 108 sends a server name list to the application 121.

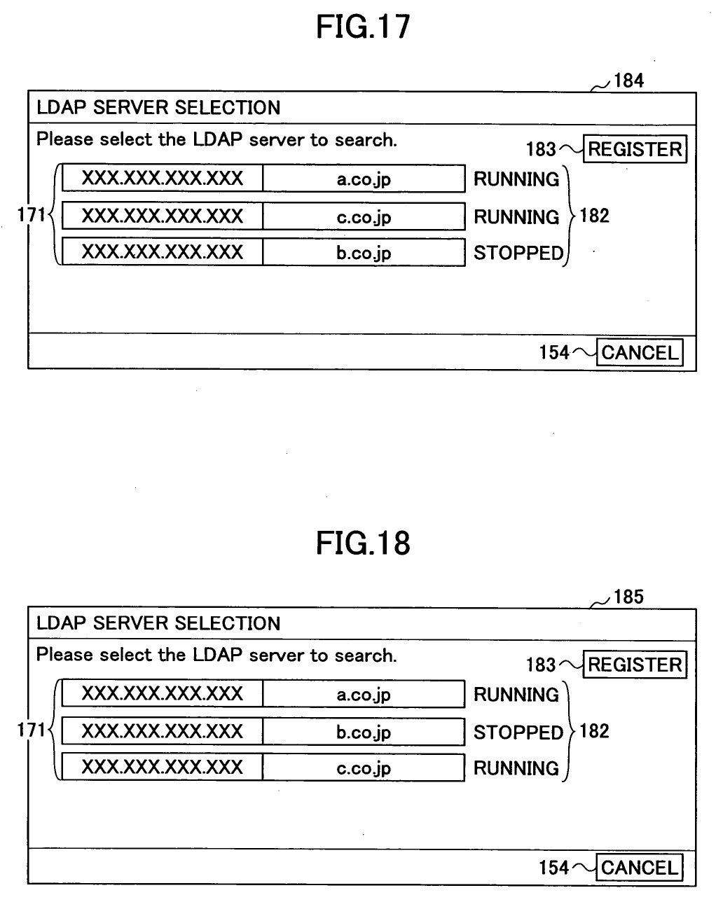

FIG. 17 is a diagram showing a display state of showing the server name list sent from the service management module 108. A screen 184 shown in FIG. 17 shows LDAP server buttons 171, state display fields 182, a registration button 183, and a cancel button 154.

The LDAP server buttons 171 are buttons for selecting one of the LDAP servers listed in the screen 184 to search. The state display fields 182 show states of respective LDAP servers such as “RUNNING”, “STOPPED”, and a like. In a case shown in FIG. 17, an LDAP server specified by “b.co.jp” is currently stopped.

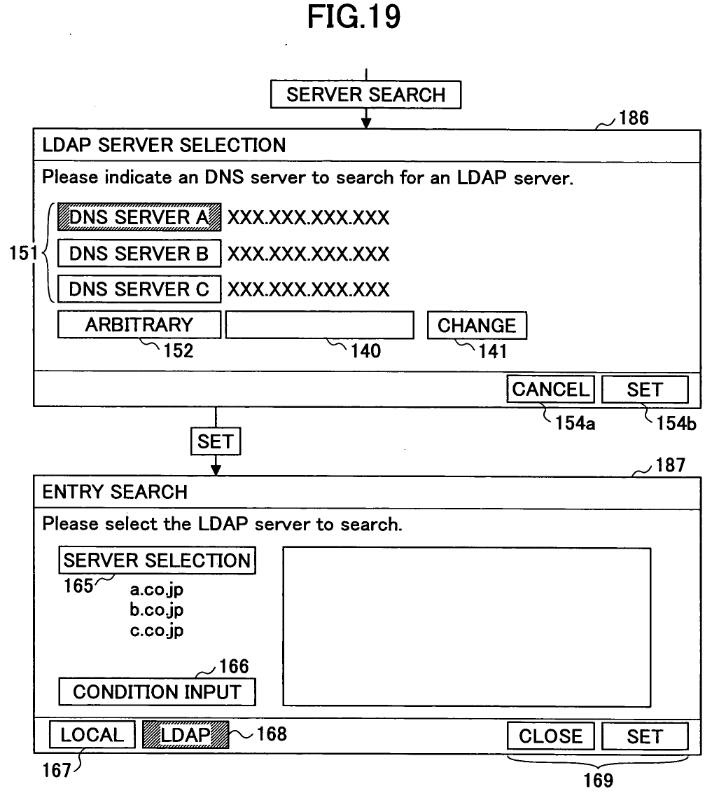

It should be noted that the LDAP servers listed in the screen 184 shown in FIG. 17 may be sorted and listed alphabetically. FIG. 18 is a diagram showing an example displaying the LDAP servers being alphabetically sorted.

Next, in the process which does not require a registration of the LDAP servers by using the SRV records as described above, a screen flow in a case of indicating a DNS server only will be described with reference to FIG. 19.

A screen 186 shown in FIG. 19 is a screen for indicating the DNS server to search for the LDAP server. The screen 186 shows DNS server buttons 151, an arbitrary button 152, an input field 140, a change button 141, a cancel button 154a, and a set button 154b.

At the screen 186, when the set button 154b is pressed, a screen 187 is displayed. The screen 187 displays three LDAP server names under a server selection button 165.

As described above, by simply setting the DNS server, it is possible to search for information from all LDAP servers acquired from one of the DNS servers. In addition, as described above, it is possible to search for information from the LDAP servers being currently running.

Next, authentication settings will be described. Even if the DNS server is searched for, and the SRV records are acquired from the DNS server, authentication information is not indicated for the LDAP server. Accordingly, it is required to indicate the authentication information for each of the LDAP server every time.

In the following, a method for omitting an indication process for indicating the authentication information will be described. First, a screen 191 shown in FIG. 19 will be described. The screen 191 shown in FIG. 19 is a screen for indicating the authentication information by selecting one of items “REPRESENTATIVE”, “PRIVATE”, and “ENTER” as an authentication type.

For example, the item “REPRESENTATIVE” is to indicate the authentication information used representatively in a group. The item “PRIVATE” is to individually indicate the authentication information. The item “ENTER” is to manually enter the authentication information.

The screen 191 shows DNS server buttons 151, an arbitrary button 152, an input field 140, a change button 141, and an authentication information indication field 192. In the authentication information indication field 192, the authentication information can be set representatively, privately, or manually for each of the DNS servers.

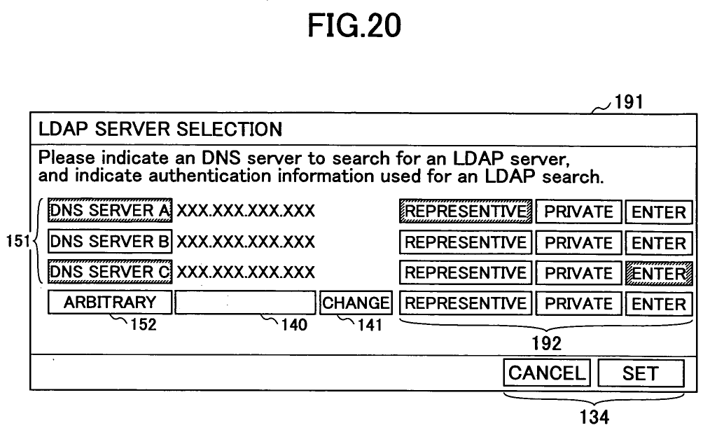

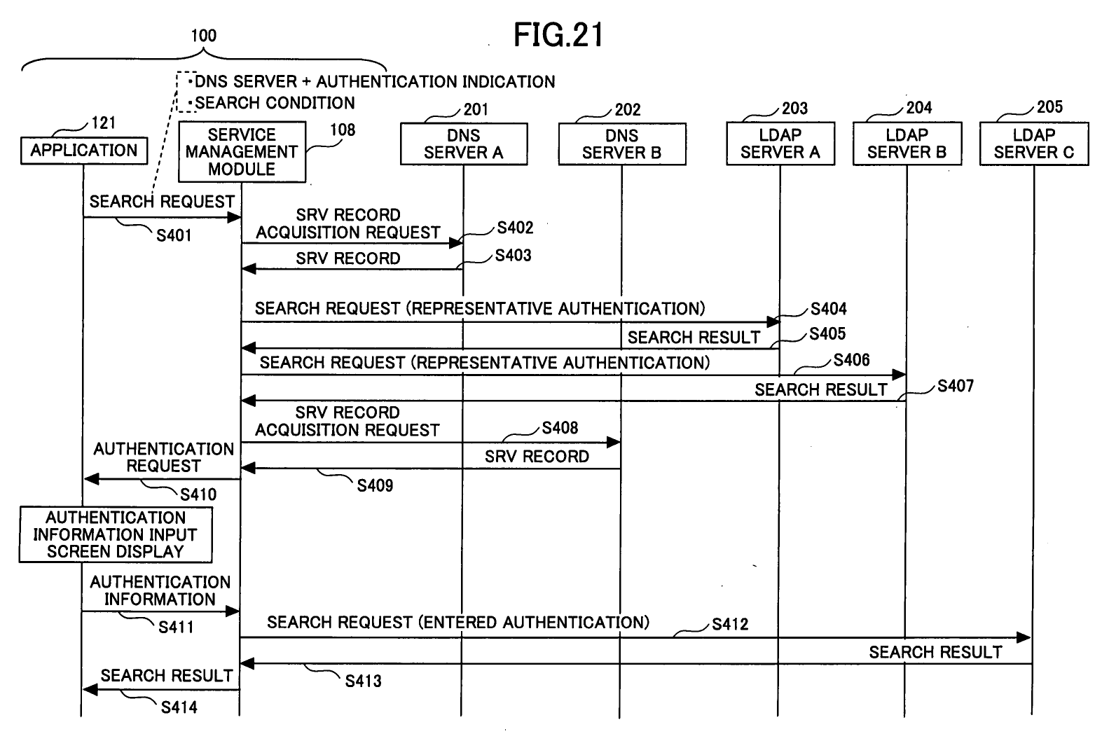

In FIG. 20, the authentication information is representatively set for the LDAP server-A, and the authentication information is privately set for the LDAP server-C. A process concerning authentications for the DNS servers will be described with reference to FIG. 21. FIG. 21 is a diagram showing a process sequence showing the process concerning the authentications for the DNS servers. In FIG. 21, the process sequence shows processes among the application 121, the service management module 108, a DNS server-A 201, a DNS server-B 202, an LDAP server-A 203, an LDAP server-B 204, and an LDAP server-C 205.

In step S401, the application 121 sends a search request to the service management module 108. In this case, for example, the DNS server-A 201, an authentication indication, and a search condition are sent to the service management module 108. In step S402, the service management module 108 sends an SRV record acquisition request to the DNS server-A 201. In step S403, the DNS server-A 201 sends SRV records to the service management module 108.

Next, in step S404, the service management module 108 sends a search request to the LDAP server-A 203. In step S405, the LDAP server-A 203 sends a search result to the service management module 108.

Moreover, in step S406, the service management module 108 sends a search request to the LDAP server-B 204. In step S407, the LDAP server-B 204 sends a search result to the service management module 108.

Next, in step S408, the service management module 108 sends an SRV record acquisition request to the DNS server-C 202. In step S409, DNS server-A 201 sends SRV records to the service management module 108.

In step S410, since the authentication information is manually set for the LDAP server-C 205, the service management module 108 sends an authentication request to the application 121. In step S411, the application 121 displays an authentication information screen, and authentication information entered by a user is sent to the service management module 108. In step S412, the service management module 108 sends a search request to the LDAP server-C 205. In step S412, the service management module 108 sends a search request to the LDAP server-C 205. In step S413, the LDAP server-C 205 sends a search result to the service management module 108.

In step S414, the service management module 108 sends the search results acquired from the LDAP server-A 203, the LDAP server-B 204, and the LDAP server-C 205, to the application 121.

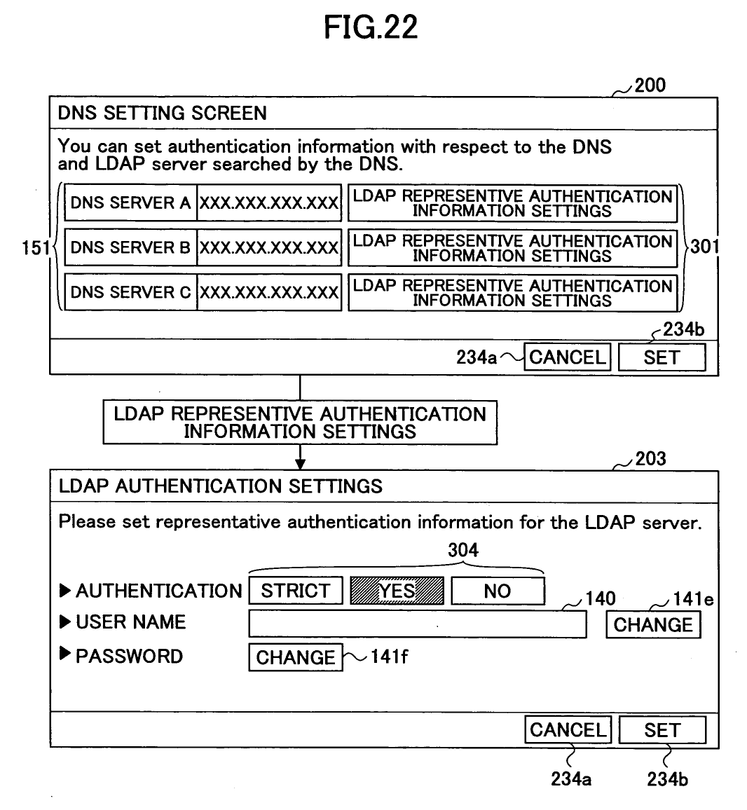

Next, in a case of representatively indicating the authentication information, as a screen for setting the authentication information for each of the LDAP servers found for each DNS server, a screen 200 shown in FIG. 22 will be described. The screen 200 shows DNS server buttons 151, an LDAP representative authentication information setting buttons 301, a cancel button 234a, and a set button 234b.

The LDAP representative authentication information setting buttons 301 are used to display a next screen for setting the authentication information. As shown in the screen 200 in FIG. 22, the LDAP representative authentication information setting buttons 301 are provided to the DNS servers, respectively.

At the screen 200, one of the LDAP representative authentication information setting buttons 301 is pressed, a screen 203 is displayed. The screen 203 shows an authentication buttons 304, an input field 140, change buttons 141e and 141f, a cancel button 234a, and a set button 234b.

The authentication buttons 304 are used to set information concerning the authentication, and include a button for a strict authentication, a button for a simple authentication, and a button for omitting the authentication. The input field 140 is used to input a user name.

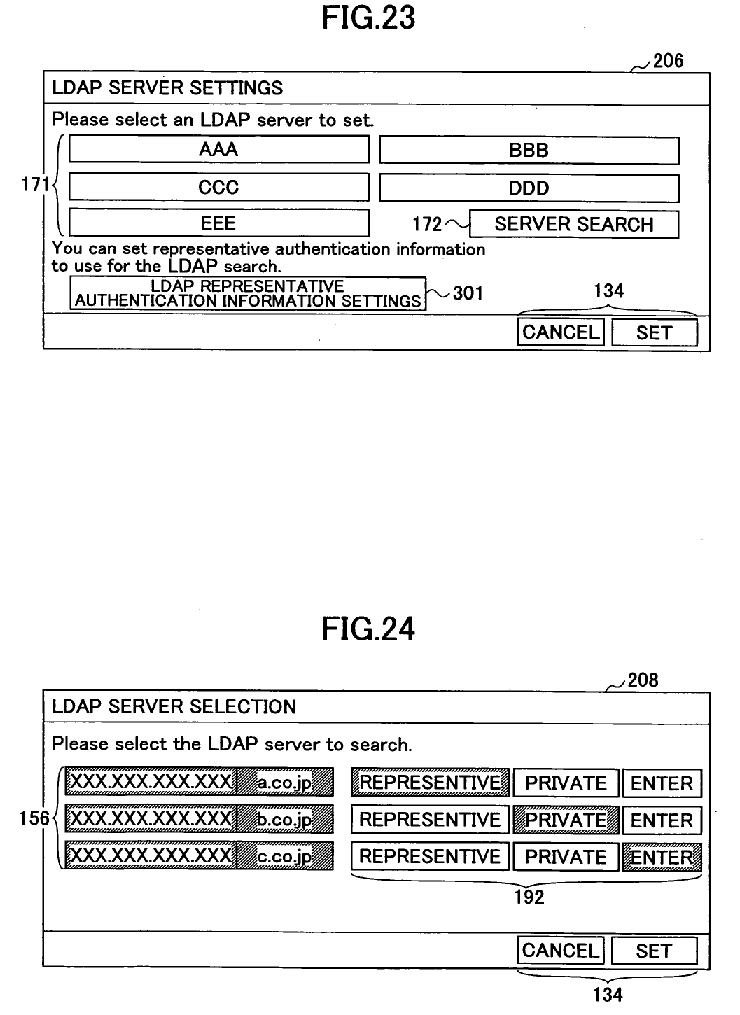

By conducting the above-described settings and pressing the set button 234b, it is possible to conduct LDAP authentication settings. Next, referring to FIG. 23, a screen will be described in a case of a registration regardless of the DNS server.

A screen 206 shown in FIG. 23 shows LDAP server buttons 171, a server search button 172, an LDAP representative authentication information setting button 301, the cancel and set buttons 134. At the screen 206, a user selects one LDAP server by pressing one of the LDAP server buttons 171, and presses the LDAP representative authentication information setting button 301. The screen 203 described with reference to FIG. 22 is displayed. Accordingly, the user can set information concerning the authentication at the screen 203.

Next, a screen for indicating the representative authentication, the private authentication, or the manually entered authentication will be described with reference to FIG. 24. The screen 208 shown in FIG. 24 shows LDAP server buttons 156, the cancel and set buttons 134, and an authentication information indication field 192.

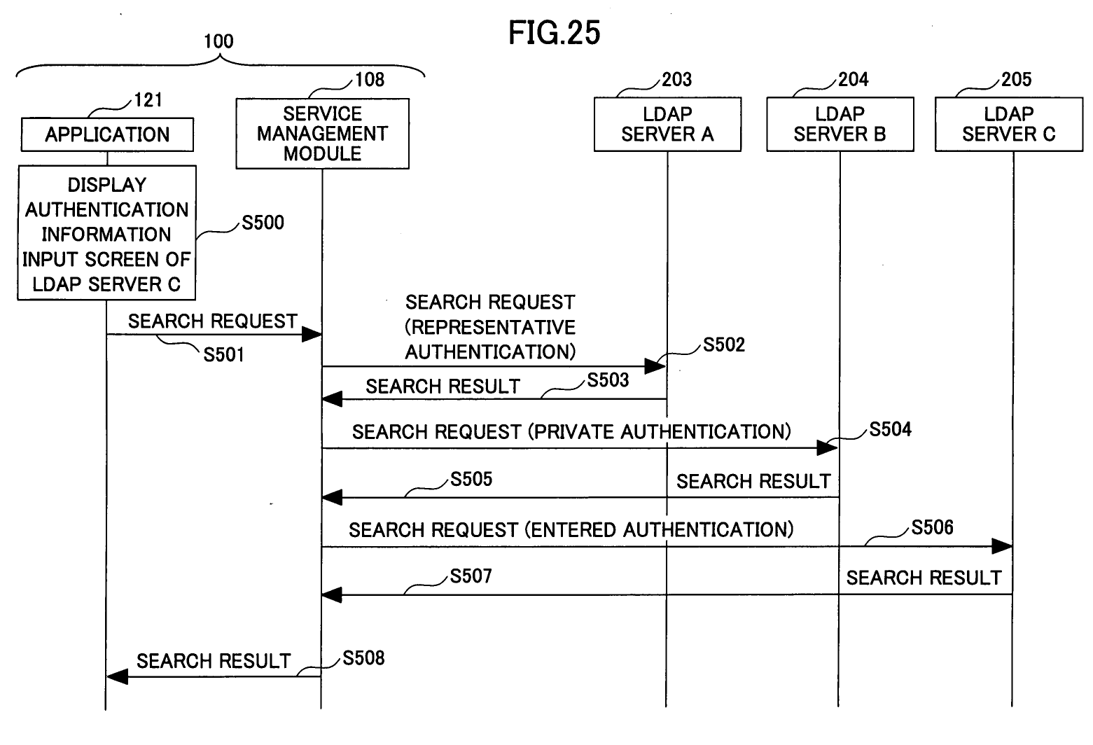

In the authentication information indication field 192, items “REPRESENTATIVE”, “PRIVATE”, and “ENTER” are provided as an authentication type for each of the LDAP servers, so as to indicate one of the items “REPRESENTATIVE”, “PRIVATE”, and “ENTER” for the authentication information. In a case of indicating the authentication type for each LDAP server, a process concerning a search will be described with reference to FIG. 25. FIG. 25 is a diagram showing a process sequence in the process concerning the search in the case of indicating the authentication type for each LDAP server. The process sequence in FIG. 25 corresponds to the settings at the screen 208 shown in FIG. 24.

First, in step S500, the application 121 displays an authentication information input screen of the LDAP server-C 205 to cause a user to input authentication information, since the item “ENTER” is indicated as the authentication type for the LDAP server-C 205. Next, in step S501, the application 121 sends a search request to the service management module 108. In step S502, the service management module 108 sends a search request indicating the representative authentication to the LDAP server-A 203. In step S503, the LDAP server-A 203 sends a search result to the service management module 108 in response to the search request received in the step S502.

Next, in step S504, the service management module 108 sends a search request indicating the private authentication to the LDAP server-B 204. In step S505, the LDAP server-B 204 sends a search result to the service management module 108 in response to the search request received in the step S504.

In the step S506, the service management module 108 sends a search request indicating the entered authentication, which shows the authentication information previously entered by the user, to the LDAP server-B 204. In step S507, the LDAP server-B 204 sends a search result in response to the search request received in the step S506, to the service management module 108.

In step S508, the service management module 108 sends all search results acquired from the LDAP server-A 203, the LDAP server-B 204, and the LDAP server-C 205, to the application 121. The application 121 may display the search results for each of the LDAP server-A 203, the LDAP server-B 204, and the LDAP server-C 205.

Alternatively, for example, the search result may be displayed every search, and the user may be asked to select whether or not a next search is conducted.

Moreover, in addition to setting the authentication type for each LDAP server, the authentication type may further set for each DNS server, and a priority may be set to valid the authentication type of either one of the LDAP server and the DNS server. In accordance with the priority, the authentication may be conducted.

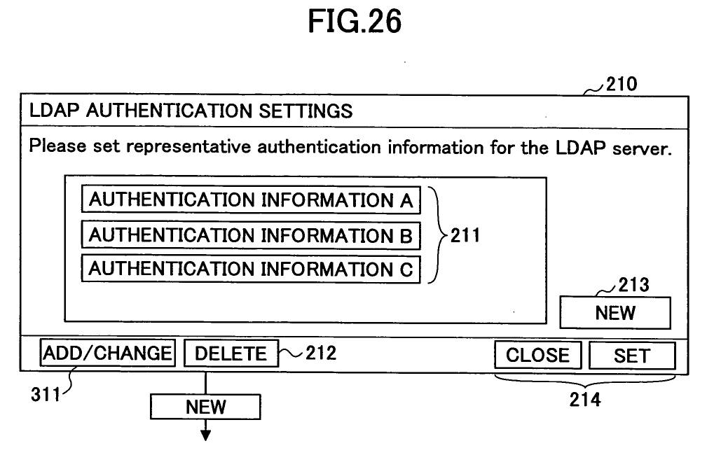

Next, a process will be described in that authentication information is prepared for several representative authentications beforehand and successively attempted. FIG. 26 is a diagram showing a screen 210 for setting the representative authentication with respect to the LDAP server. The screen 210 in FIG. 26 shows authentication information buttons 211, an add/change button 311, a delete button 212, a new button 213, and close and set buttons 214.

The authentication information buttons 211 are displayed corresponding to the authentication information for the several representative authentications prepared beforehand. The add/change button 311 is used to add further authentication information or change the authentication information listed as the authentication information button 211. The delete button 212 is used to delete the authentication information listed as the authentication information buttons 211. The new button 213 is used to add new authentication information.

At the screen 210, when the new button 213 is pressed, the screen 203 (see FIG. 22) is displayed. At the screen 203, the authentication information is set.

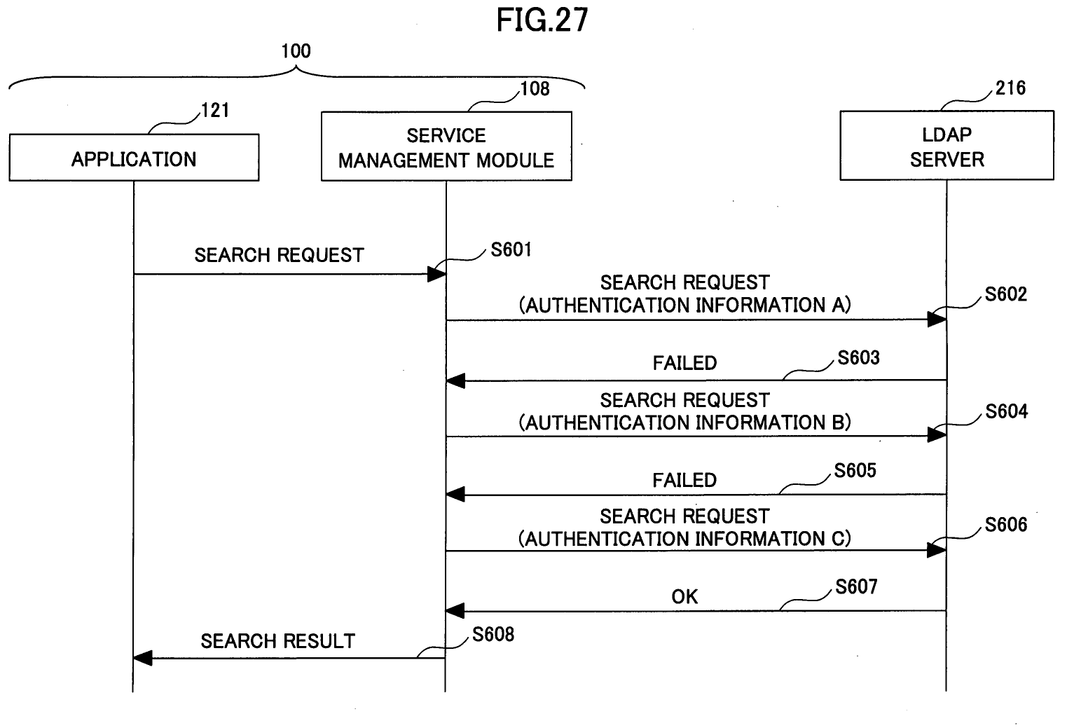

As described above, a process in a case of preparing multiple authentication information will be described with reference to FIG. 27. FIG. 27 is a diagram showing a process sequence in the process in a case in that the authentication information is defined for the several representative authentications beforehand. In step S601, the application 121 sends a search request to the service management module 108. In step S602, the service management module 108 sends a search request indicating authentication information A to LDAP server 216. Since the LDAP server 216 cannot authenticate by using the authentication information A, in step S603, the LDAP server 216 sends a failure notice to the service management module 108.

Since the authentication using the authentication information A is failed, in step S604, the service management module 108 sends a search request indicating authentication information B to the LDAP server 216. Since the LDAP server 216 cannot authenticate by using the authentication information B, in step S605, the LDAP server 216 sends the failure notice to the service management module 108.

Since the authentication using the authentication information B is failed again, in step S606, the service management module 108 sends a search request indicating authentication information C to the LDAP server 216. Since the LDAP server 216 can authenticate successfully, in step S607, the LDAP server 216 sends an OK notice to the service management module 108. In step S608, the service management module 108 sends a search result to the application 121.

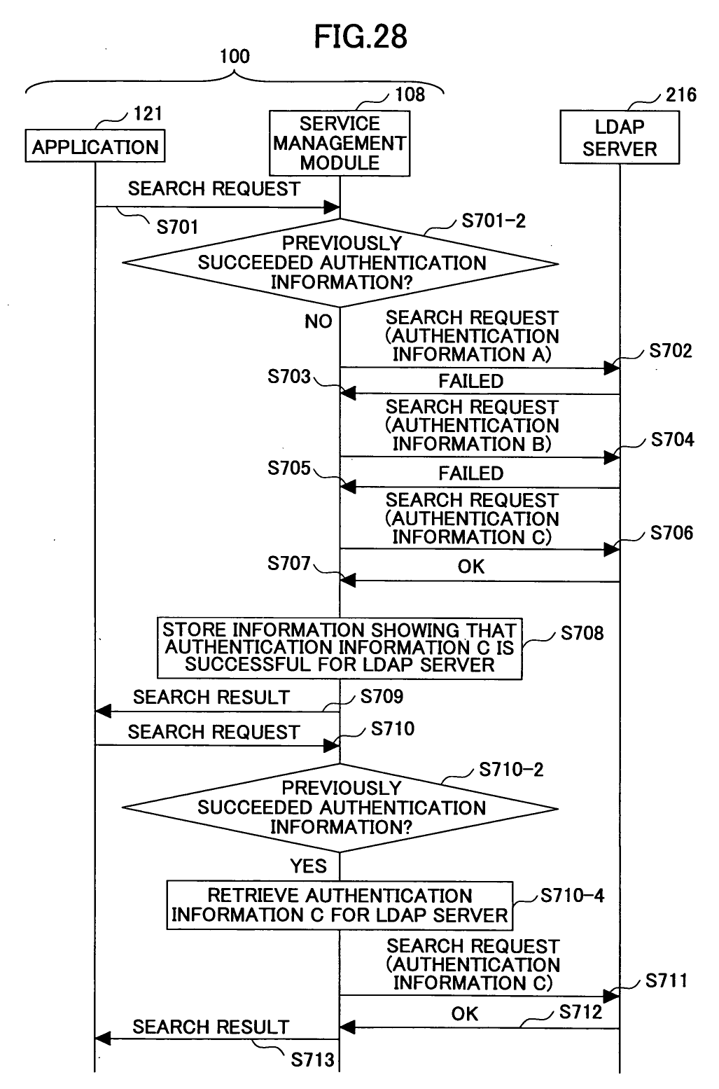

Next, a process, in which the authentication information successfully authenticated is recorded to use for a next authentication, will be described with reference to FIG. 28. FIG. 28 is a diagram showing a process sequence in the process in that the authentication information successfully authenticated is recorded to use for a next authentication. The process is conducted among the application 121, the service management module 108, and the LDAP server 216.

In step S701, the application 121 sends a search request to the service management module 108. In step S701-2, the service management module 108 determines whether or not there is authentication information which was successfully authenticated at a last authentication. In this case, it is assumed that there is no authentication information which was successfully authenticated at the last authentication. The service management module 108 successfully attempts authentication information prepared for each of the several representative authentications.

In step S702, the service management module 108 sends a search request indicating the authentication information A to the LDAP server 216. Since the LDAP server 216 cannot authenticate by using the authentication information A, in step S703, the LDAP server 216 sends a failure notice to the service management module 108.

Since the authentication is failed, in step S704, the service management module 108 sends a search request using the authentication information B to the LDAP server 216. The LDAP server 216 still cannot authenticate even if using the authentication information B. In step S705, the LDAP server 216 sends a failure notice to the service management module 108.

Since the authentication is failed again, in step S706, the service management module 108 sends a search request using the authentication information C to the LDAP server 216. The LDAP server 216 can authenticate by using the authentication information C this time. In step S707, the LDAP server 216 sends an OK notice to the service management module 108.

In step S708, the service management module 108 stores information showing that the LDAP server 216 can authenticate successfully by using the authentication information C. After that, in step S709, the service management module 108 sends a search result to the application 121.

In step S710, the application 121 sends a search request to the service management module 108 again. The service management module 108 determines that the authentication can be successful by using the authentication information C in step S710-2, and retrieves the authentication information C in step S710-4. Subsequently, in step S711, the service management module 108 sends a search request to the LDAP server 216. In step S712, the LDAP server 216 sends an OK notice to the service management module 108. In step S713, the service management module 108 sends a search result to the application 121.

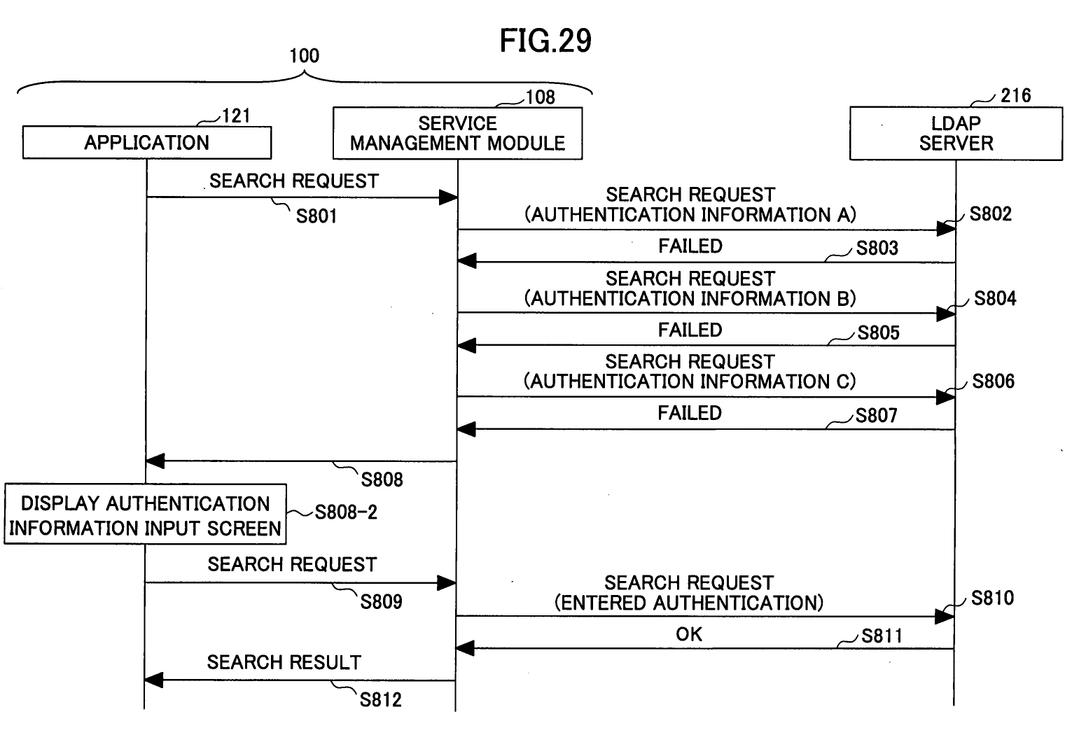

Next, referring to FIG. 29, a process for displaying an authentication information input screen when the authentication is failed will be described. FIG. 29 is a diagram showing a process sequence in the process for displaying the authentication information input screen when the authentication is failed. The process is conducted among the application 121, the service management module 108, and the LDAP server 216.

In step S801, the application 121 sends a search request to the service management module 108.

In step S802, the service management module 108 sends a search request using the authentication information A to the LDAP server 126. The LDAP server 216 cannot authenticate by using the authentication information A. In step S803, the LDAP server 216 sends a failure notice to the service management module 108.

Since the authentication is failed, in step S804, the service management module 108 sends a search request indicating the authentication information B to the LDAP server 216. The LDAP server 216 cannot authentication by using the authentication information B. In step S805, the LDAP server 216 sends a failure notice to the service management module 108.

Since the authentication is failed again, in step S806, the service management module 108 sends a search request indicating authentication information C to the LDAP server 216. The LDAP server 216 cannot authentication even if using the authentication information C. In step S807, the LDAP server 216 sends a failure notice to the service management module 108.

Since the authentication cannot be successful with respect to all of the authentication information A, the authentication information B, and the authentication information C, in step S808, the service management module 108 sends an authentication error to the application 121. In step S808-2, in response to the authentication error, the application 121 displays the authentication information input screen, and the user enters the authentication information. In step S809, the application 121 sends a search request to the service management module 108, again. In this case, in step S810, the service management module 108 sends a search request indicating the authentication information entered by the user in the step S808-2, to the LDAP server 216. In step S811, the LDAP server 216 sends an OK notice to the service management module 108. In step S812, the service management module 108 sends a search result to the application 121.

In a case in that the authentication is failed at a certain LDAP server, different from the above-described case, a process for requesting a search of another LDAP server can be conducted. In this case, the application 121 may display a result showing whether or not the search is successfully conducted by the LDAP server, every time the search is requested to the LDAP server. By displaying the result, the user can recognize which LDAP server can successfully authenticate, and the service management module 108 can maintain information concerning that the authentication is successfully conducted and the search is conducted by the LDAP server.

As described above, the present invention can provide a network device for using a service provided through a network, a service using method for using a service provided through a network, a service using program product, and a computer-readable recording medium recorded with a service using program for causing a computer to use a service through a network.

The present invention is not limited to the specifically disclosed embodiments, and variations and modifications may be made without departing from the scope of the present invention.

The present application is based on the Japanese Priority Applications No. 2004-271711 filed on Sep. 17, 2004 and No. 2004-271712 filed on Sep. 17, 2004, the entire contents of which are hereby incorporated by reference.

What is claimed is:

1. A network device capable of communicating to a Domain Name System server including service records and using a service provided by a predetermined server, said network device comprising:
a receiving part receiving the service records from the Domain Name System server;
an acquiring part acquiring service information for using the predetermined server; and
a using part using the service based on the service information.

2. The network device as claimed in claim 1, wherein the service information includes a host name or an IP address of the predetermined server, and a port number.

3. The network device as claimed in claim 2, wherein the using part sends a service request for using the service with respect to the host name or the IP address, and the port number to the predetermined server.

4. The network device as claimed in claim 3, wherein the using part sends authentication information for using the service to the predetermined server.

5. The network device as claimed in claim 4, wherein the authentication information is device authentication information defined for each of network devices.

6. The network device as claimed in claim 4, wherein the authentication information is private authentication information defined for each user of network devices.

7. The network device as claimed in claim 4, wherein the authentication information is stored beforehand in the network device.

8. The network device as claimed in claim 4, wherein the authentication information is entered by a user of the network device.

9. The network device as claimed in claim 1, further comprising a determining part determining whether or not the service is available to be used based on the service information.

10. The network device as claimed in claim 1, wherein the service is an Lightweight Directory Access Protocol, an File Transfer Protocol, an Simple Mail Transfer Protocol, or an Server Message Block.

11. A service using method for communicating to a Domain Name System server including service records and using a service provided by a predetermined server, said service using method comprising:
receiving step receiving the service records from the Domain Name System server;
acquiring step acquiring service information for using the predetermined server; and
using step using the service based on the service information.

12. The service using method as claimed in claim 11, wherein the service information includes a host name or an IP address of the predetermined server, and a port number.

13. The service using method as claimed in claim 12, wherein the using step sends a service request for using the service with respect to the host name or the IP address, and the port number to the predetermined server.

14. The service using method as claimed in claim 13, wherein the using part sends authentication information for using the service to the predetermined server.

15. The service using method as claimed in claim 14, wherein the authentication information is device authentication information defined for each of network devices.

16. The service using method as claimed in claim 14, wherein the authentication information is private authentication information defined for each user of network devices.

17. The service using method as claimed in claim 14, wherein the authentication information is stored beforehand in a network device.

18. The service using method as claimed in claim 14, wherein the authentication information is entered by a user of a network device.

19. The service using method as claimed in claim 11, further comprising a determining part determining whether or not the service is available to be used based on the service information.

20. The service using method as claimed in claim 11, wherein the service is an Lightweight Directory Access Protocol, an File Transfer Protocol, an Simple Mail Transfer Protocol, or an Server Message Block.

21. A service using program product for causing a computer to communicate to a Domain Name System server including service records and using a service provided by a predetermined server, said service using method comprising:
receiving code receiving the service records from the Domain Name System server;
acquiring code acquiring service information for using the predetermined server; and
using code using the service based on the service information.

22. A computer-readable recording medium recorded with a service using program for causing a computer to communicate to a Domain Name System server including service records and using a service provided by a predetermined server, said service using method comprising:
receiving code receiving the service records from the Domain Name System server;
acquiring code acquiring service information for using the predetermined server; and
using code using the service based on the service information.

23. A network device capable of communicating to a Domain Name System server including service records and using a service provided by a predetermined server, said network device comprising:
a receiving part receiving the service records from the Domain Name System server;
an acquiring part acquiring service information for using the predetermined server; and
a setting part setting information for using the service based on the service information.

24. The network device as claimed in claim 23, wherein the service information includes a host name or an IP address of the predetermined server, and a port number.

25. The network device as claimed in claim 23, wherein the receiving part acquires the service records from the Domain Name System server selected by a user.

26. The network device as claimed in claim 23, wherein the setting part sets authentication information for using the service.

27. The network device as claimed in claim 26, wherein the authentication information device authentication information defined for each of network devices.

28. The network device as claimed in claim 26, wherein the authentication information is private authentication information defined for each user of network devices.

29. The network device as claimed in claim 26, wherein the authentication information is stored beforehand in the network device.

30. The network device as claimed in claim 26, wherein the authentication information is entered by a user of the network device.

31. The network device as claimed in claim 30, wherein the authentication information is entered when the service is used.

32. The network device as claimed in claim 23, wherein the service is an Lightweight Directory Access Protocol, an File Transfer Protocol, an Simple Mail Transfer Protocol, or an Server Message Block.

33. A service using method for communicating to a Domain Name System server including service records and using a service provided by a predetermined server, said service using method comprising:
receiving step receiving the service records from the Domain Name System server;
acquiring step acquiring service information for using the predetermined server; and
a setting step setting information for using the service based on the service information.

34. The service using method as claimed in claim 33, wherein the service information includes a host name or an IP address of the predetermined server, and a port number.

35. The service using method as claimed in claim 33, wherein the receiving step acquires the service records from the Domain Name System server selected by a user.

36. The service using method as claimed in claim 33, wherein the setting step sets authentication information for using the service.

37. The service using method as claimed in claim 36, wherein the authentication information device authentication information defined for each of network devices.

38. The service using method as claimed in claim 36, wherein the authentication information is private authentication information defined for each user of network devices.

39. The service using method as claimed in claim 36, wherein the authentication information is stored beforehand in a network device.

40. The service using method as claimed in claim 36, wherein the authentication information is entered by a user of a network device.

41. The service using method as claimed in claim 40, wherein the authentication information is entered when the service is used.

42. The service using method as claimed in claim 33, wherein the service is an Lightweight Directory Access Protocol, an File Transfer Protocol, an Simple Mail Transfer Protocol, or an Server Message Block.

43. A service using program product for causing a computer to communicate to a Domain Name System server including service records and using a service provided by a predetermined server, said service using method comprising:
receiving code receiving the service records from the Domain Name System server;
acquiring code acquiring service information for using the predetermined server; and
a setting code setting information for using the service based on the service information.

44. A computer-readable recording medium recorded with a service using program for causing a computer to communicate to a Domain Name System server including service records and using a service provided by a predetermined server, said service using method comprising:
receiving code receiving the service records from the Domain Name System server;
acquiring code acquiring service information for using the predetermined server; and
a setting code setting information for using the service based on the service information.
